(19) United States
(12) Patent Application Publication
(10) Pub. No.: US 2021/0235639 A1
(43) Pub. Date: Aug. 5, 2021

(54) TRELLIS

(71) Applicant: McCormick & Company, Incorporated, Hunt Valley, MD (US)

(72) Inventors: Andrew Gordon WATSON, Berkeley, CA (US); Chee Choong PHANG, Selangor (MY)

(73) Assignee: McCormick & Company, Incorporated, Hunt Valley, MD (US)

(21) Appl. No.: 16/614,246

(22) PCT Filed: May 17, 2018
(86) PCT No.: PCT/US2018/033225

§ 371 Date: Nov. 15, 2019

(51) Int. Cl. A01G 17/06; A01G 17/00

(52) U.S. Cl. CPC A01G 17/06; A01G 17/005

(57) ABSTRACT

A black pepper trellis system. A method of growing black pepper plants is described including constructing a continuous trellis system including vertical and horizontal vine support lines, where the vertical lines are up to 5 meters high and are up to 50 centimeters apart, covering up to 20 acres of soil or more, and growing pepper vines up and across the vertical and horizontal lines, resulting in a dense hedgerow of pepper plants and enhanced black pepper yield per acre. The trellis system and black pepper per acre produced by the above system processes is also described.

### CROSS REFERENCE TO RELATED APPLICATION

The present application claims priority to U.S. Provisional Application Ser. No. 62/507,527, filed May 17, 2017, the disclosure of which is expressly incorporated by reference herein in its entirety.

### TECHNICAL FIELD

The field of art to which this invention generally pertains is black pepper, and particularly growing of the same.

### BACKGROUND

Black pepper is a flowering vine cultivated for its fruit which is typically dried for use as a seasoning. The dried fruit is known as a peppercorn. The pepper plant grows as a vine, typically up to about 10 feet or more in height, on supporting trees, poles, or other supporting structures, as with most growing vines. A single plant stem can yield up to 2,000 fruiting spikes. The spikes are typically collected and dried, and the peppercorns stripped off the spikes. As with all commercial undertakings, there is a constant search for new technologies and improvements to existing technologies to increase the efficiency and effectiveness of the growth and production of such plants and the seasoning products they provide.

### BRIEF SUMMARY

A method of growing black pepper plants in soil is described including constructing a trellis system including vertical and horizontal vine support lines, where the vertical lines are up to 5 meters high and are up to 50 centimeters apart, and growing pepper vines up and across the vertical and horizontal lines, resulting in a dense hedgerow of pepper plants and enhanced black pepper yield per acre.

Additional embodiments include: the method described above covering up to 20 acres of soil; the method described above covering up to 10 acres of soil; the method described above where the horizontal lines include at least 3 lines up to 5 meters high; the method described above where the horizontal lines are up to 2.25 meters high; the method described above where the horizontal lines are up to 1.5 meters high; the method described above where the vertical lines are up to 40 centimeters apart; the method described above where the vertical lines are up to 35 centimeters apart; the method described above where the vertical lines are up to 30 centimeters apart; the method described above where the vertical lines are up to 25 centimeters apart; the method described above where the vertical lines comprise coir fiber; the method described above where the horizontal lines comprise steel cable; the method described above where the vertical lines comprise nylon rope; the method described above where the vertical lines are between 45 and 90 degrees from the horizontal; the method described above where the vertical and horizontal lines comprise fishnet; the method described above where the fishnet has square openings up to 30 centimeters on a side; and the method described above where the fishnet has square openings up to 3 centimeters on a side. The black pepper per acre produced by the above processes is also described.

A trellis system is also described including a system of horizontal vine support lines, supporting a system of vertical vine support lines, the vertical lines being up to 5 meters high and up to 50 centimeters apart, and the horizontal lines being at least 30 centimeters apart, where the system is particularly adapted for supporting a dense hedgerow of pepper plants and enhanced black pepper yield per acre of soil.

Additional embodiments include: the trellis system described above covering up to 20 acres of soil; the trellis system described above covering up to 10 acres of soil; the trellis system described above where the vertical lines comprise coir fiber; the trellis system described above where the horizontal lines comprise steel cable; the trellis system described above where the vertical lines comprise nylon rope; the trellis system described above where the vertical lines are between 45 and 90 degrees from the horizontal; the trellis system described above where the vertical and horizontal lines comprise fishnet; the trellis system described above where the fishnet has square openings up to 3 centimeters on a side; the trellis system described above where the fishnet has square openings up to 10 centimeters on a side; the trellis system described above where the fishnet has square openings up to 15 centimeters on a side; and the trellis system described above where the fishnet has square openings up to 30 centimeters on a side.

These and additional embodiments are further described below.

### BRIEF DESCRIPTION OF THE DRAWINGS

FIG. 1 demonstrates an embodiment of a trellis support system as described herein.

FIG. 2 demonstrates schematically an embodiment of a trellis support system as described herein.

FIGS. 3A and 3B demonstrate schematically a top view and a side view of a trellis support system as described herein.

FIGS. 4A, 4B and 4C demonstrate examples of poles used in the trellis system described herein.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, can inherently contain certain errors necessarily resulting from the standard deviation found in measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

As a vine, pepper plants have evolved to climb trees and other similar structures to extend themselves in the vertical direction they require in order to grow higher than competing types of vegetation and find sunlight for photosynthesis and growth without having to expend their own energy to lay down self-supporting wood tissues. In order to assist in this natural process, as with all vines, human intervention through the use of poles, living trees, and other structural supports assist to help facilitate this vertical growth have been employed.

With continuously increasing appetites for herbs and spices, and the ever decreasing availability of natural resources to produce such herbs and spices, such as land, water and manual labor willing to work out of doors under the hot sun, there is a constant search for ways to improve the effectiveness and efficiency for using these natural resources. The system described herein has been found to be an advancement in the way pepper plants can be grown which can maximize both the land use and other natural resources required to produce such pepper plants on a commercial scale. By providing a trellis system which facilitates the growth of the vine both vertically and horizontally, the concentration and density of growth (e.g., plants and, more importantly, square feet of fruit bearing surface area per acre) of the plants can be increased without negative effects on the plants themselves. In addition to horizontal growth of the vines, and the generation of a continuous system of growth for the vines, greater heights for the plants can be generated as well through the trellis system described herein. Maximizing both the speed of growth and the density of growth to maximize the vine density per acre is a primary advantage of the system described herein. Furthermore, because the trellis can be constructed in pre-determined and systematic ways, it can present the growing plants in a pre-determined and systematic pattern which can lend itself to all manner of labor-saving mechanized operations, such as fertilization, operations to control pests, diseases and weeds, pruning and harvesting.

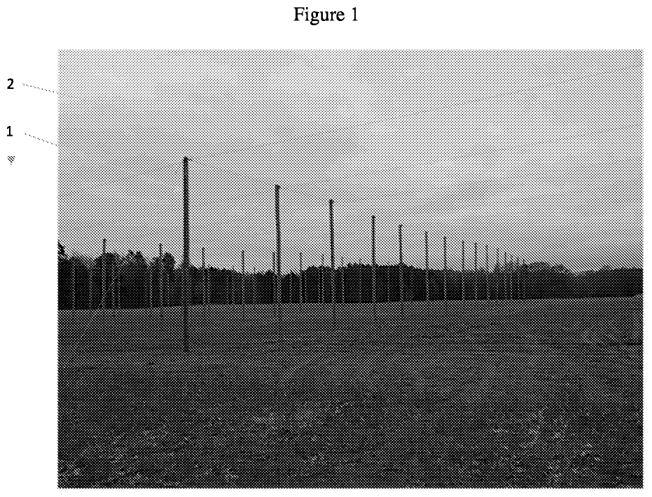

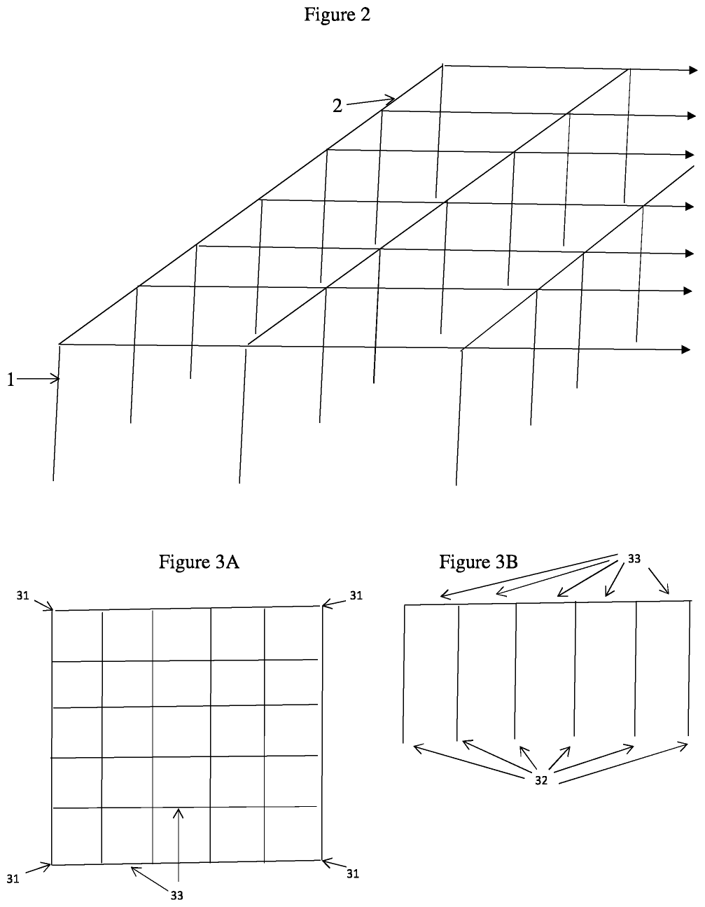

For example, while heights above 1.5 meters are not uncommon, the system described herein can be designed to reach 5 meters or more. And while single rows of plants is not uncommon, the system described herein has a plurality of joined top cables which run horizontally both longitudinally along the rows and laterally across the rows in one continuous system which can cover as much as 10 acres, 20 acres, or more. As seen in FIG. 1, wooden poles (1) are typically used to support the continuous system in the vertical direction. They can be place just at the 4 corners (31) of the grid as demonstrated in FIG. 3A, or intermittently at regular intervals as demonstrated in FIG. 1, depending on such things as the height of the trellis system desired and how much weight the cable system is anticipated to have to carry. While they can additionally provide some support for the growth of a vine in the vertical direction, their primary purpose is to support the cable system required for the continuous growth system described herein. The primary cables (2) for providing the outer-most support for the system are also shown in FIG. 1, which would typically be the cables of the most substance for supporting the overall interior cable system, also shown schematically in FIG. 2. FIG. 3A demonstrates a top view of a trellis system as described herein, and FIG. 3B a side view of a trellis system as described herein, with vertical supports (32) for the vines shown and horizontal supports (33) for the vines demonstrated.

As demonstrated schematically in FIG. 2, the utilization of the vertical and horizontal vine support system will produce a grid for maximizing the utilization of the ground area for vine growth, among other things. While any materials which promote the growth and attachment of the vines can be strung both in the vertical and horizontal directions between the supporting poles to complete the continuous system, coir twine, coir fiber, and heavy duty cables are particularly useful for this purpose. The vertical supporting poles can be any cross section, e.g., circular, square or rectangular, and of any diameter sufficient to hold the weight of the cable system containing the vines, e.g., for a 10 meter height, a two inch diameter pole could be adequate depending on the horizontal spacing of the additional vertical cables. Any material can be used for the cable material strung between the poles, such as nylon or other synthetic material (with or without a roughened surface), although natural twine is preferred for its typically naturally rough surfaces and ability to hold moisture and allow for the adventitious roots on the main stems of the pepper plant to cling onto the twine and prevent it from falling, with coir fiber being particularly advantageous in this regard.

The use of fishnet between the supporting poles to provide both the vertical and horizontal growth lines has also been found to be particularly useful for providing the desired growth support for the pepper vines described herein, including obtaining the density of growth desired. And while any spacing (e.g., 25 cm, 30 cm, etc.) which promotes dense growth while allowing adequate sunlight, moisture, etc. to permeate the trellis system, 1 inch square fishnet of thin diameter of about 2 mm or smaller has been found to be particularly useful. It should also be noted that while substantially vertical poles and cables at 90 degrees is desired, angles as small as 45 degrees can also be used. In addition, while the system described herein is particularly described for use with pepper plants, at least some of the benefits are transferrable and can be used for plants other than pepper plants, for example, herb or spice vine plants in general, including the vanilla vine, for example.

As described above, a method of growing black pepper plants is described utilizing a continuous trellis system. The system includes vertical and horizontal vine support lines spaced so as to maximize the use of the acreage employed, while letting in enough sunlight, moisture, etc. to allow the plants to flourish. The vertical lines can be up to 5 meters high or more. They should also be as close as possible to maximize the vine growth surface area per trellis, but also open enough to allow enough sunlight and moisture in to all the vines to remain healthy. Typically the vertical lines are spaced up to 50 centimeters apart. The trellis is also most useful when covering up to 10 acres of soil. In such an environment, healthy pepper vines grow up and across the vertical and horizontal lines producing a dense hedgerow of pepper plants and enhanced black pepper yield per acre. The horizontal lines typically include at least 3 lines up to at least 3 meters high, e.g. 1 meter, 1.25 meter, 1.5 meter, 1.75 meter, 2 meters, 2.25 meters, 2.5 meters, 2.75 meters and 3 meters. The vertical lines are typically up to 50 centimeters (cm) apart, for example, 25 cm, 30 cm, 35 cm, 40 cm, 45 cm and 50 cm.

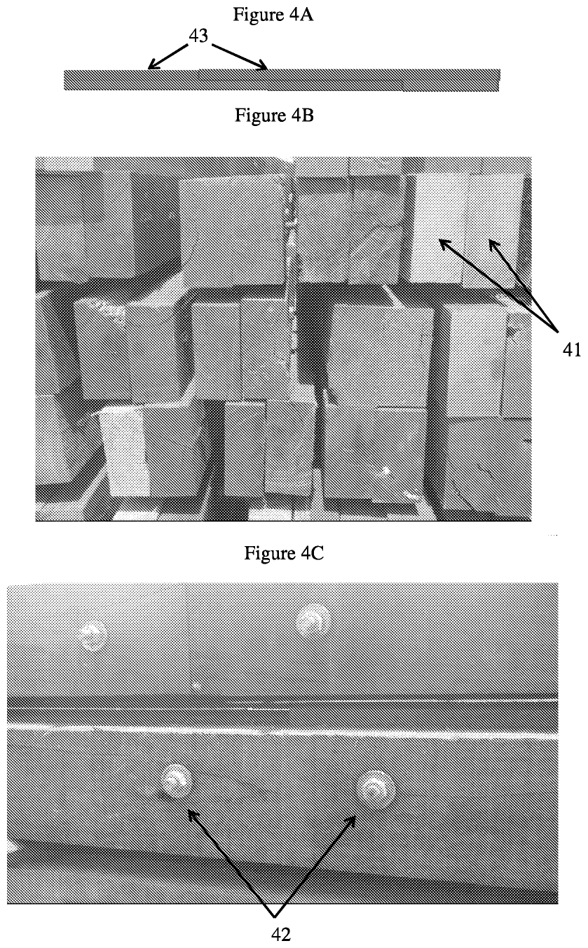

While any pole material which has the requisite strength to support the trellis grid can be used, such as steel or other metal, composite materials, etc., wood poles are typically used to provide the main support for the vertical and horizontal lines which make up the trellis system described herein. As demonstrated, for example, in FIGS. 4A, 4B and 4C, poles are shown made from milled timber, e.g., tropical hardwood. As shown, two pieces (41) of two inch by four inch milled timber are bolted together (42) to make a four inch by four inch pole. Although a single four inch by four inch pole of the appropriate length can be used, typically 2 or 3 shorter pieces (43) are used, which are then bolted together to make up a composite pole of the appropriate lengths, e.g., 6.5 meters (m), 5.5 m, 4.5 m, etc.

Similarly, any materials which can support the vertical lines can be used as the horizontal supporting lines (e.g., 2 and 33 in the figures), galvanized steel cable is particularly useful from a strength and durability perspective. The vertical lines, in addition to the support they provide for the plants, can also be of a material which facilitates the growth and attachment of the vines thereto, including coir fiber, and polymer lines/rope such as nylon, with or without a roughened surface.

As described above, the vertical lines are typically between about 45 and 90 degrees in orientation from the horizontal lines, e.g., 45, 50, 55, 60, 65, 70, 75, 80, 85, and 90 degrees. The vertical and horizontal lines can also include fishnet, having openings up to 30 centimeters on a side, for example, up to 2 cm, up to 3 cm, up to 4 cm, up to 5 cm, up to 10 cm, up to 15 cm, up to 20 cm, up to 25 cm, and up to 30 cm, or more.

### EXAMPLE

On a 10 acre piece of land suitable for growing pepper plants, a trellis system is put in place by securing in the ground wooden poles up to 7.5 meters tall and 6 to 8 inches in diameter if round poles or 3 to 4 inches square in milled timber. The poles are placed in a grid pattern up to 10 meters apart in the longitudinal direction and up to 4 meters apart in the lateral direction. Steel cables about ¼″ in diameter are then securely fastened to the poles in both a longitudinal and lateral grid to provide support for vertical and horizontal lines to be fastened below the cables. Coir fiber/rope 6 (millimeter) mm in diameter is then secured to the cables from 25 to 30 cm apart extending the entire length down to the ground. Pepper plants are then planted below each coir fiber/rope to begin the growing process for the plants up the coir fibers and across the steel cables.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of growing black pepper plants comprising,
constructing a trellis system including vertical and horizontal vine support lines,
wherein the vertical lines are up to 5 meters high and are up to 50 centimeters apart, and
growing pepper vines up and across the vertical and horizontal lines, resulting in a dense hedgerow of pepper plants and enhanced black pepper yield per acre.

2.-17. (canceled)

18. The black pepper per acre produced by the process of claim 1.

19. A trellis system comprising,
a system of horizontal vine support lines, supporting
a system of vertical vine support lines
the vertical lines being up to 5 meters high and up to 50 centimeters apart, and
the horizontal lines being at least 30 centimeters apart,
wherein the system is particularly adapted for supporting a dense hedgerow of pepper plants and enhanced black pepper yield per acre of soil.

20. The trellis system of claim 19, covering up to 20 acres of soil.

21. The trellis system of claim 20, covering up to 10 acres of soil.

22. The trellis system of claim 19, wherein the vertical lines comprise coir fiber.

23. The trellis system of claim 19, wherein the horizontal lines comprise steel cable.

24. The trellis system of claim 19, wherein the vertical lines comprise nylon rope.

25. The trellis system of claim 19, wherein the vertical lines are between 45 and 90 degrees from the horizontal.

26. The trellis system of claim 19, wherein the vertical and horizontal lines comprise fishnet.

27. The trellis system of claim 26, wherein the fishnet has square openings up to 3 centimeters on a side.

28. The trellis system of claim 26, wherein the fishnet has square openings up to 10 centimeters on a side.

29. The trellis system of claim 26, wherein the fishnet has square openings up to 15 centimeters on a side.

30. The trellis system of claim 26, wherein the fishnet has square openings up to 30 centimeters on a side.
